(19) United States
(12) Patent Application Publication
(10) Pub. No.: US 2007/0156871 A1
(43) Pub. Date: Jul. 5, 2007

(54) Secure dynamic HTML pages

(76) Inventors: Michael Braun, Ludwigshafen (DE); Ralf M. Rath, Mannheim (DE)

Correspondence Address: MINTZ, LEVIN, COHN, FERRIS, GLOVSKY & POPEO, P.C., 9255 TOWNE CENTER DRIVE, SUITE 600, SAN DIEGO, CA, 92121, US

(21) Appl. No.: 11/322,624

(22) Filed: Dec. 30, 2005

(51) Int. Cl. G06F 15/173

(52) U.S. Cl. 709/223

(57) ABSTRACT

A computer-implemented method and computer program product for filtering web content at a portal/intranet server. A web page is received at a portal/intranet server having hypertext markup language (HTML) content embedded with one or more active scripts. The one or more active scripts are parsed from the HTML content. A filter determines whether any of the one or more active scripts are potentially dangerous to a requesting client computer. The web page is then filtered of active scripts that are determined to be potentially dangerous to the requesting client computer.

### BACKGROUND

The Internet is a worldwide system of computer networks—a network of networks—in which users of one computer (i.e. a client) can access information from another computer (i.e. a server). The Internet uses existing public telecommunication networks to transmit information between computers. Technically, Internet is distinguished from other communication networks by its use of a set of communication protocols, generally called the Transmission Control Protocol/Internet Protocol (TCP/IP). Two fairly recent adaptations of Internet technology, the intranet and the extranet, also make use of the TCP/IP protocol.

The most widely used part of the Internet is referred to as the World Wide Web (often abbreviated to “WWW” or referred to simply as “the web”). The web is characterized by its use of hypertext, a system of instant cross-referencing in which the hypertext markup language (HTML) is used to write and code a web page or web site. In most web sites, certain words, phrases, or objects can be coded to appear in a different color, underlined, or otherwise designated to be selectable to transfer a user to another relevant or related site or page. Sometimes there are buttons, images, or portions of images that are “clickable.” If a user simply moves a cursor's pointer over a hypertext spot on a Web site and the pointer changes into a hand, this indicates that the spot can be clicked to transfer the user to another site.

While the Internet and the web provide a mechanism for instantaneously accessing information from anywhere in the world, there are some risks which are increasing in frequency and voracity. For instance, HTML content that was edited by an unknown third party, or accessed from a remote computer, can include content that can harm a user's computer when that content is opened or viewed. Security zone concepts provided by browsers such as Microsoft's Internet Explorer (IE) do not adequately protect a computer, particularly if that computer can access HTML content via a local intranet. A browser can also include settings that can be adjusted to turn off certain types of HTML content, however such solutions do not adequately filter good content from bad.

One type of harmful content can be found in the form of an active script such as JavaScript. JavaScript is an interpreted programming or script language that is easier and faster to code than more structured and compiled languages such as C and C++. JavaScript code can be imbedded in HTML pages and interpreted and processed by a web browser (or client computer). While script languages generally take longer to process than compiled languages, they are very useful for shorter programs. JavaScript is used in web site development to do such things as automatically change a formatted date on a web page, cause a linked-to page to appear in a popup window, or cause text or a graphic image to change. JavaScript can also be used to create harmful processes, which are easily embedded in and unknowingly accessed from normal HTML content.

### SUMMARY

This document discloses a portal/intranet server filter to protect a user's computer from harmful Internet content.

In one aspect, a method for filtering web content at a portal/intranet server is disclosed. The method is preferably implemented on a computer such as a portal/intranet server. The method includes the steps of receiving a web page having hypertext markup language (HTML) content embedded with one or more active scripts, and parsing the one or more active scripts from the HTML content. The method further includes determining whether any of the one or more active scripts are potentially dangerous to a requesting client computer, and filtering the web page of active scripts that are determined to be potentially dangerous to the requesting client computer.

In another aspect, a method includes receiving a web page at a portal/intranet server, the web page having hypertext markup language (HTML) content embedded with one or more active scripts. The method further includes parsing the web page in the portal/intranet server to remove at least one active script from the HTML content, generating a filtered web page without the at least one active script, and passing the filtered web page to a requesting client computer.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a computer network having a web content filtering mechanism.

FIG. 2 illustrates communication between a content server and a client computer.

FIG. 3 is a flowchart illustrating a method of filtering web content.

Like reference symbols in the various drawings indicate like elements.

### DETAILED DESCRIPTION

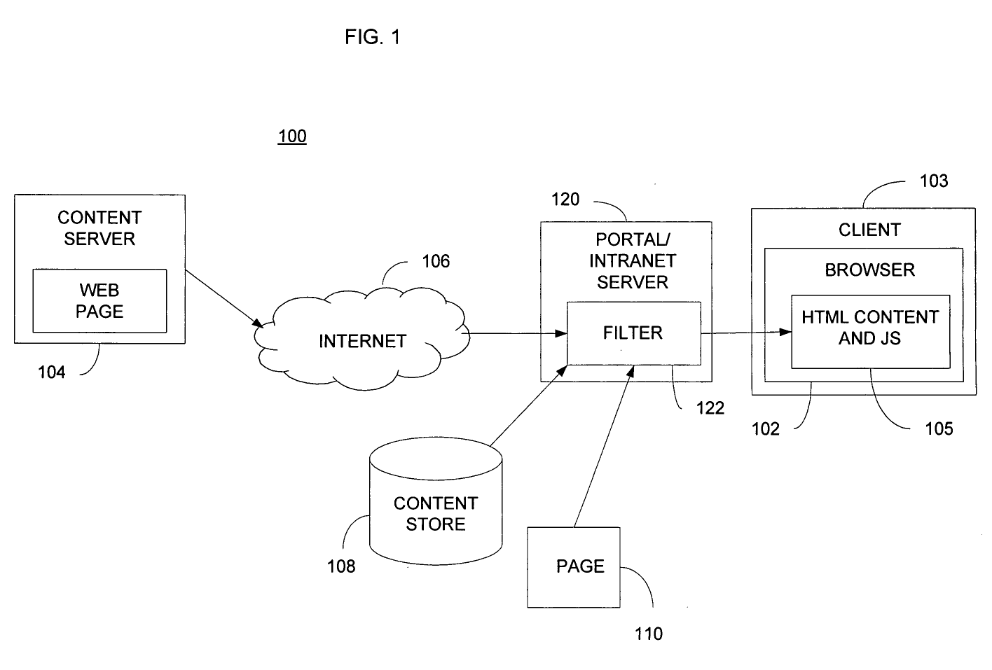

This document describes a portal/intranet server filter that filters Web page content to remove potentially dangerous active scripts. FIG. 1 illustrates a computer network 100 in which the filter can be suitably employed. In the computer network 100, a browser 102 running in a client computer 103 receives, processes and displays HTML content 105 that has been generated and assembled in the form of a web page 107 by a content server 104. Upon request from the client computer 103, each web page 107 is dynamically generated by the content server 104 and stored in a cache (not shown) before delivery to the requesting client computer 103 via the Internet 106.

Other sources of the web page 107 can be a content store 108 or a web page 110 that are associated with a portal/intranet server 120. When the client computer 103 is associated with the portal/intranet server 120, the web page 107 can be configured to be received first by the portal/intranet server 120. It should be understood to those of skill in the art that the computer network 100 can include more than one client computer 103 and more than one content server 104.

The web page 107 can include HTML content 105 with one or more active scripts embedded in the HTML content 105. The active scripts can be JavaScripts, and can be potentially dangerous to the client computer 103 if opened or viewed by the browser 102. In accordance with a preferred embodiment, the portal/intranet server 120 includes a filter 122 that parses the web page 107 and separately identifies the HTML content 105 from any active scripts. Any active scripts that are potentially dangerous, or otherwise selected by an end user to be of no value, are removed from the web page by the filter 122.

In some embodiments, for performance reasons only web pages that are not edited or editable by the end user are filtered. The filter 122 can be configured for dedicated file types, content sources, or editable documents. The web page 107 can be filtered as it is being displayed by the browser 102, or filtered when it is stored by the portal/intranet server 120. When active scripts are removed, the remaining HTML content (and acceptable active scripts, which are recombined with the HTML content) are passed on to the client computer as a filtered web page. Accordingly, the filter 122 protects the end user and the client computer 103 from potentially harmful Web content.

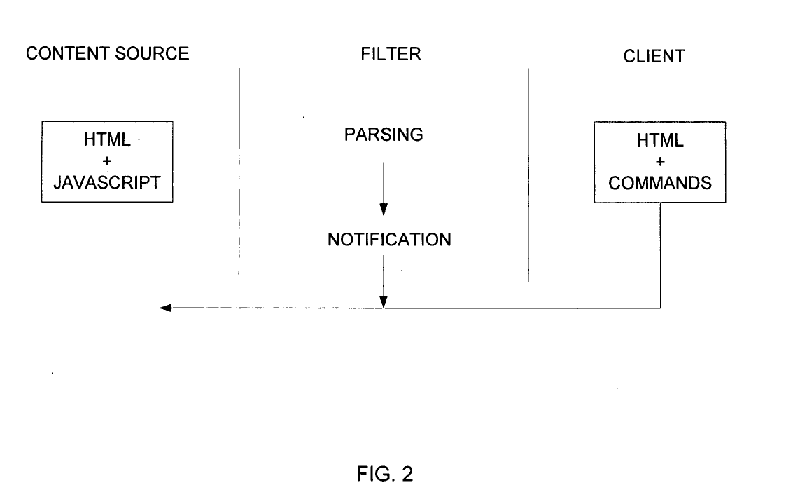

As illustrated in FIG. 2, a notification can be generated for any active scripts removed. The notification can include a link for the end user to a removed active script, for later controlled access to that active script by the end user. The notification can be provided in the form of a command displayed in the browser 102. Further, deleted active scripts can be replaced by safe JavaScript, either by the filter 122 or by the portal/intranet server 120.

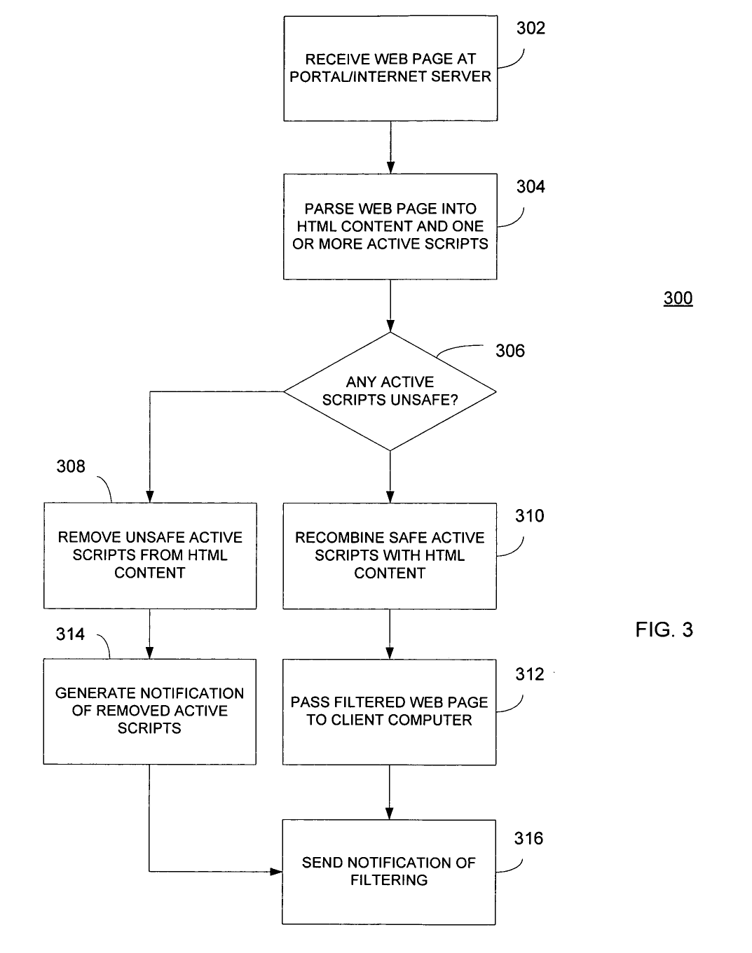

FIG. 3 is a flowchart of a method 300 of filtering web content. At 302, a portal/intranet server receives a web page. The web page includes both HTML content and one or more active scripts, such as a script written in JavaScript. At 304, a filter in the portal/intranet server parses the web page into the HTML content and the one or more active scripts. At 306, the filter determines whether the one or more active scripts includes any unsafe active scripts, i.e. active scripts which, if opened by a browser, could adversely affect the requesting client computer or the end-user. Alternatively, the filter can determine whether any of the active scripts are safe, i.e. end-user generated or otherwise safe to open.

At 308, the filter removes any unsafe active scripts from the HTML content of the web page. Any safe active scripts are recombined, or otherwise left embedded, with the HTML content at 310. At 312, the filtered web page (including the requested HTML content and any safe active scripts) are passed by the filter to the requesting client computer. At 314, the filter or other component in the portal/intranet server generates a notification of the removed active scripts. The notification can include a link that is to be sent to the requesting client computer for access to removed active scripts, which access can be separate from opening the requested web page. At 316, the notification is sent to the client computer. The notification can also be sent to the sending content server that generated and assembled the original unfiltered web page.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

1. A computer-implemented method for filtering web content, the method comprising:
receiving a web page at a portal/intranet server, the web page having hypertext markup language (HTML) content embedded with one or more active scripts;
parsing the web page in the portal/intranet server to remove at least one active script from the HTML content;
generating a filtered web page without the at least one active script; and
passing the filtered web page to a requesting client computer.

2. A method in accordance with claim 1, wherein parsing the web page further includes identifying the at least one active script from the one or more active scripts that is potentially dangerous to the requesting client computer.

3. A method in accordance with claim 1, wherein parsing the web page further includes identifying, among the one or more active scripts, whether any active scripts are end-user generated.

4. A method in accordance with claim 3, wherein generating a filtered web page further includes recombining the end-user generated active scripts with the HTML content.

5. A computer-implemented method for filtering web content at a portal/intranet server, the method comprising:
receiving a web page having hypertext markup language (HTML) content embedded with one or more active scripts;
parsing the one or more active scripts from the HTML content;
determining whether any of the one or more active scripts are potentially dangerous to a requesting client computer; and
filtering the web page of active scripts that are determined to be potentially dangerous to the requesting client computer.

6. A method in accordance with claim 5, further comprising passing the filtered web page to the requesting client computer.

7. A method in accordance with claim 6, further comprising determining whether any of the one or more active scripts are end-user generated active scripts.

8. A method in accordance with claim 7, wherein passing the filtered web page to the requesting client computer further includes recombining end-user active scripts with the HTML content.

9. A method in accordance with claim 5, further comprising generating a notification that indicates the filtering of active scripts from the web page.

10. A method in accordance with claim 9, further comprising generating a link for the requesting client computer to the active scripts that are filtered from the web page.

11. A computer program product, tangibly embodied in an information carrier, the computer program product being operable to cause a data processing apparatus to:
receive a web page having hypertext markup language (HTML) content embedded with one or more active scripts;
parse the one or more active scripts from the HTML content;
determine whether any of the one or more active scripts are potentially dangerous to a requesting client computer; and
filter the web page of active scripts that are determined to be potentially dangerous to the requesting client computer.

12. A computer program product in accordance with claim 11, and being further operable to cause a data processing apparatus to pass the filtered web page to the requesting client computer.

13. A computer program product in accordance with claim 12, and being further operable to cause a data processing apparatus to determine whether any of the one or more active scripts are end-user generated active scripts.

14. A computer program product in accordance with claim 13, and being further operable to cause a data processing apparatus to recombine end-user active scripts with the HTML content.

15. A computer program product in accordance with claim 11, and being further operable to cause a data processing apparatus to generating a notification that indicates the filtering of active scripts from the web page.

16. A computer program product in accordance with claim 15, and being further operable to cause a data processing apparatus to generate a link for the requesting client computer to the active scripts that are filtered from the web page.
